(19) United States
(12) Patent Application Publication
(10) Pub. No.: US 2025/0336057 A1
(43) Pub. Date: Oct. 30, 2025

(54) SMARTPHONE PHOTOGRAPHY ADAPTED FOR SCREEN ORIENTATIONS AND SOCIAL MEDIA

(71) Applicant: Adeia Imaging LLC, San Jose, CA (US)

(72) Inventors: Tao Chen, Palo Alto, CA (US); Reda Harb, Tampa, FL (US); Charles Dasher, Lawrenceville, GA (US)

(21) Appl. No.: 18/651,370

(22) Filed: Apr. 30, 2024

(51) Int. Cl. G06T 7/00; H04N 23/63

(52) U.S. Cl. CPC G06T 7/001; H04N 23/632

(57) ABSTRACT

Systems and methods are provided herein for accommodating the needs of media sharing and storage services associated with applications by integrating the media format parameters of the media sharing and storage services with the media-capturing application of a user device. Once integrated via an API request, a bounding box for capturing media corresponding to the media format parameters of a selected media sharing and storage service is displayed on the interface of the media-capturing application. The media-capturing application of the user device subsequently captures storable media. Metadata associated with the stored media is accessed by the media sharing and storage service to identify the image data, within the stored media, that is in the preferred format parameters for uploading to a media sharing and storage application.

### BACKGROUND

This disclosure is related to a user interface and storage structure for media captured with a camera.

### SUMMARY

Media sharing and storage services can be accessed via the Internet, allowing for upload of media using a user device. User devices may upload media to the media sharing and storage services using applications provided by the media sharing and storage services, which are installed on the user device. The uploaded media is stored remotely in a network storage and is optionally shared with other user devices. For example, images are captured by a camera application (e.g., native camera application of the user device) by using a viewfinder preview to frame a scene and receiving a user-interface selection to capture an image of the scene. Captured images are uploaded to the media sharing and storage service associated with an application installed on the user device. However, such native camera applications capture images in a standard format that may be different from the media format parameters required by the media sharing and storage service associated with an application for uploading media. For example, media sharing and storage services associated with applications (e.g., social media applications) may require media (e.g., photos and videos) to be uploaded in a particular size, format, and/or appearance. Different social media networks (and even features within such platforms) may require pictures and videos to have specific parameters (e.g., aspect ratio, orientation, video clip length, etc.). For example, Instagram™ Stories™ (tall videos) require uploaded images to have a portrait orientation and an aspect ratio of 9:16.

Often, when media is first captured using a native camera application, uploading the media in accordance with the media format parameters required by a media sharing and storage service results in frustrating the intent of the images/videos, because the image is initially captured in a different format than what is required. When media is captured using the viewfinder of the native camera application in a standard format and subsequently uploaded to a media sharing and storage service associated with an application that requires media to be uploaded in a different format, image data from the captured media is excluded from the uploaded media. For example, if the native camera application captured an image in a 4:3 aspect ratio, portions of the image will be cut off when the image is ultimately uploaded to the media sharing and storage service associated with an application (e.g., Instagram) that requires images to be uploaded in a 9:16 aspect ratio. As another example, a native camera application captures an image of a person that takes up an entire image frame. If the image of the person is uploaded to any media sharing and storage service associated with an application that requires different media format parameters, some portion of the captured image of the person will necessarily have to be excluded (e.g., cutting off a depiction of a head or feet of the person, and thus losing critical image data and/or lowering data quality of the image). Alternatively, a user may manually crop a photo after it is captured using the native camera application, but this results in similarly undesired outcomes (e.g., if the person took up a whole length of the frame, even manual cropping would necessarily result in undesirable data loss). For example, capturing a photo in a first aspect ratio and subsequently cropping it to conform to a different aspect ratio uses more energy of the camera device, wastes the user's time and results in some portion of the photo being cut off.

In one approach, a user desires to upload an image of a particular scene to multiple media sharing and storage services associated with various applications. To upload an optimal image to each separate media sharing and storage service associated with an application, where each media sharing and storage service associated with an application requires media to be uploaded in different formats, a user would need to capture a separate image for each format required by the respective media sharing and storage service. Alternatively, to accomplish the same goal, the user would need to use the embedded camera of each media sharing and storage application that it seeks to upload media to, in order to capture the scene in the proper format for each respective media sharing and storage service. This requires the user to perform multiple actions to upload a quality image of the same scene to multiple media sharing and storage applications, which is undesirable. Additionally, each captured image intended for each respective application would be stored and uploaded separately, which is not an efficient use of storage on the user device or of network bandwidth.

To overcome these problems, example systems and methods are provided herein for accommodating the needs of media sharing and storage services associated with applications by integrating, or making accessible, the media format parameters (e.g., aspect ratio and length of time) of the media sharing and storage services with the media capturing application of a user device. In some embodiments, the camera application of a user device accesses (e.g., via an API associated with the camera application) the media format parameters associated with the various media sharing and storage services. In some implementations, the camera application of the user device displays a viewfinder preview based on image data captured by at least one camera of the user device. In some embodiments, the camera application of the user device displays a bounding box, overlayed over the viewfinder preview, that is based on the media format parameters accessed from the media sharing and storage services associated with applications installed on the device, the size of the bounding box being smaller than a size of the viewfinder preview. In some embodiments, the camera application of the device receives a user-interface input to capture media. In some embodiments, the camera application of the device automatically captures the media when the camera application determines a suitable scene for capturing or uploading. In some approaches, the media displayed by the bounding box is stored in a non-transitory memory and excludes any image data outside of the bounding box. In other additional or alternative approaches, the camera application captures and stores the media displayed by the viewfinder preview and metadata associated with the media that defines a location and size of the bounding box. For example, the metadata is accessed by the media sharing and storage services associated with applications to identify the image data, within the stored media, in the preferred format parameters for uploading.

Such systems and methods, for example, provide a user interface that allows for initial capture of a media item in the media format parameters associated with a media sharing and storage service. Thus, the system may receive user-interface inputs to create multiple media-cropping choices in a single preview and photo-capturing action. Therefore, these systems and methods provide for a more improved user interface and guidance, as the systems capture media to be uploaded to media sharing and storage services in a more efficient manner, without losing image data and without using unnecessary storage.

User interfaces of camera applications can be used to capture landscape and portrait orientation images (e.g., by physically rotating a mobile device before capturing an image). For example, when a scene is captured sequentially in landscape and portrait orientation modes, the photos will be different due to the change in position (e.g., pitch, yaw, roll, zoom, etc.) of the camera device when it is rotated from the landscape orientation to the portrait orientation. The changes in orientation prevent the user from accurately capturing the same scene in both a landscape and portrait orientation because it is difficult for a user to manually maintain the position of the camera device as it changes from one orientation to a different orientation.

To overcome these problems, in some embodiments, the camera application presents a guide to assist the user in capturing a second media item in a second orientation based on the target area captured by a first media item in a first orientation. For example, the camera application captures a first media item in a first orientation. When the user attempts to capture the same target area in a second orientation, the camera application displays a guide on the viewfinder preview for capturing the second media item in the same position as the first media item was captured in (e.g., pitch, yaw, roll, zoom, etc.). In some implementations, the guide includes positioning prompts based on the metadata associated with the first captured image and a semi-transparent overlay for allowing the user to manually determine the proper alignment. In some approaches, the semi-transparent overlay indicates whether the viewfinder preview of the second media item is aligned with the first image. The camera application then captures the second media item according to the guide. In some embodiments, the camera application automatically captures the second media item at the moment the viewfinder preview of the second media item is aligned with the semi-transparent overlay of the first image.

In some embodiments, a target area is captured in multiple aspect ratios corresponding to different media format parameters or orientations associated with media sharing and storage services. In this scenario, the camera application will store a first captured media item of the target area and a second captured media item of the target area as a pair, based on the metadata shared between the respective captured media item, where the metadata indicates that each image of the target area is captured using different media format parameters or orientations.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A depicts an example embodiment of capturing media in accordance with the media format parameters associated with media sharing and storage services, in accordance with embodiments of the disclosure.

FIG. 1B depicts an example embodiment of capturing media in accordance with the media format parameters associated with media sharing and storage services, in accordance with embodiments of the disclosure.

FIG. 2A is a schematic example of performing image analysis and recommending frames of a video for uploading to media sharing and storage services associated with applications, in accordance with embodiments of the disclosure.

FIG. 2B is a schematic example of performing image analysis and providing a bounding box in a preferred position for capturing media items to be uploaded to media sharing and storage services associated with applications, in accordance with embodiments of the disclosure.

FIG. 3 is a schematic example of capturing a scene in multiple orientations and storing the captured media items as a pair, in accordance with embodiments of the disclosure.

FIG. 4 is a schematic example of capturing a scene using multiple media format parameters and storing the captured media items as a pair, in accordance with embodiments of the disclosure.

FIG. 5 is a flow diagram of sending an API request and receiving media format parameters in response, in accordance with embodiments of the disclosure.

FIG. 6 is a flow diagram of capturing a scene in multiple orientations and storing the captured media items as a pair, in accordance with embodiments of the disclosure.

FIG. 7 is a flow diagram of capturing a scene in multiple orientations and storing the captured media items as a pair, in accordance with embodiments of the disclosure.

FIG. 8 shows illustrative devices and systems for capturing media in accordance with the media format parameters associated with media sharing and storage services, in accordance with some embodiments of this disclosure.

FIG. 9 shows illustrative devices and systems for capturing media in accordance with the media format parameters associated with media sharing and storage services, in accordance with some embodiments of this disclosure.

FIG. 10 is flowchart of a detailed illustrative process for capturing media in accordance with the media format parameters associated with media sharing and storage services, in accordance with some embodiments of this disclosure.

FIG. 11 is flowchart of a detailed illustrative process for capturing a target area of a viewfinder preview in multiple orientations, in accordance with embodiments of the disclosure.

### DETAILED DESCRIPTION

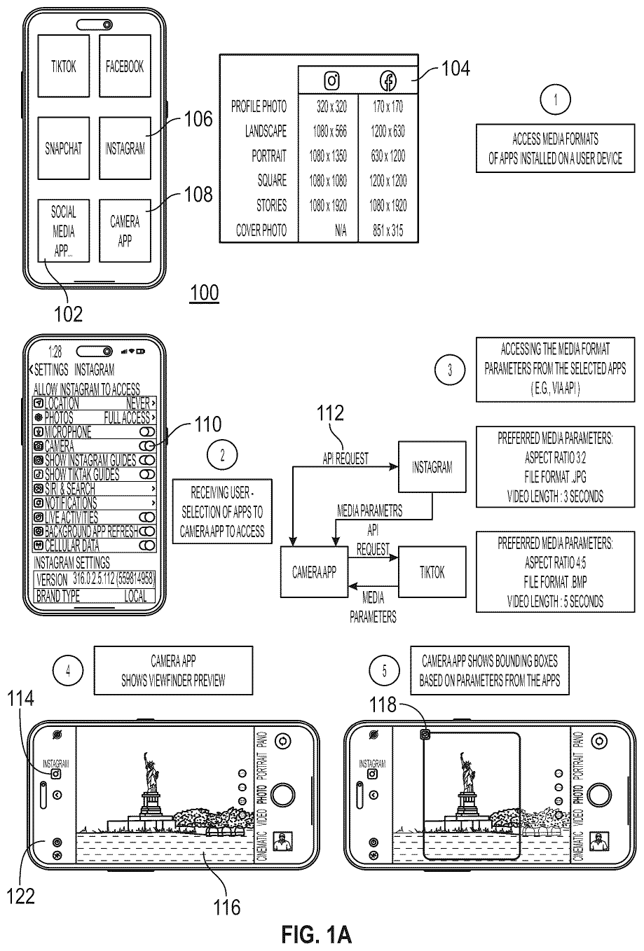

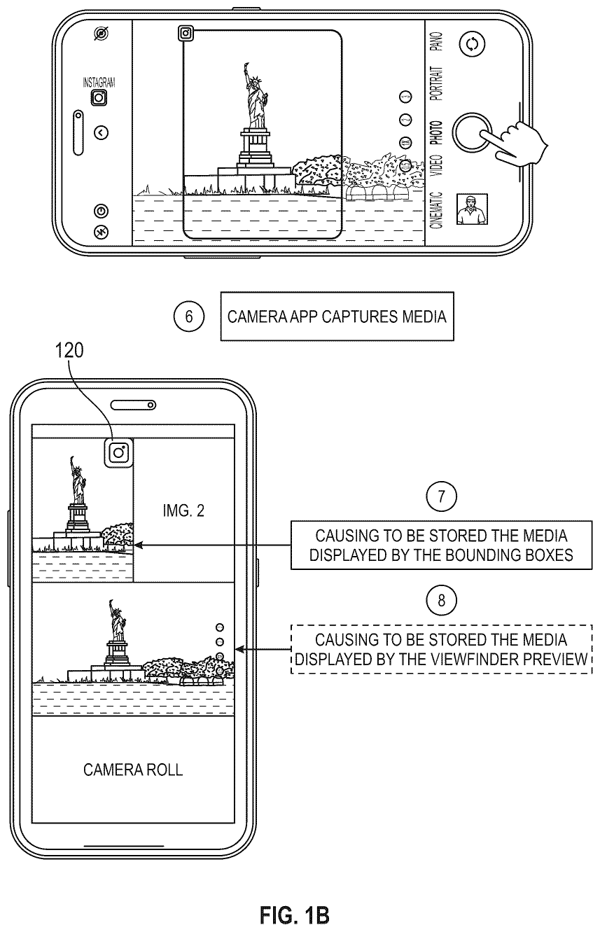

FIGS. 1A and 1B depict an example embodiment of capturing media using a camera application of a user device, in accordance with the media format parameters associated with media sharing and storage services.

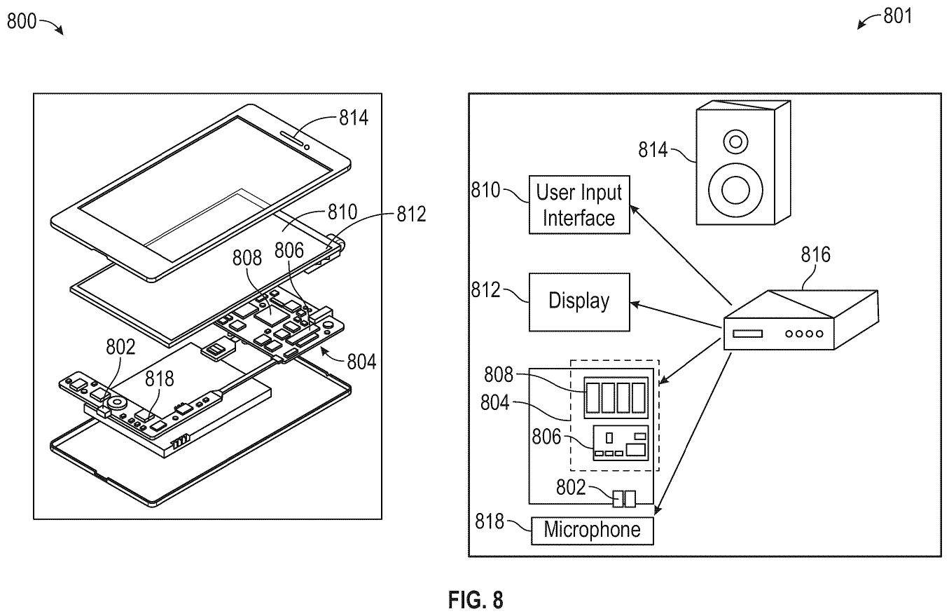

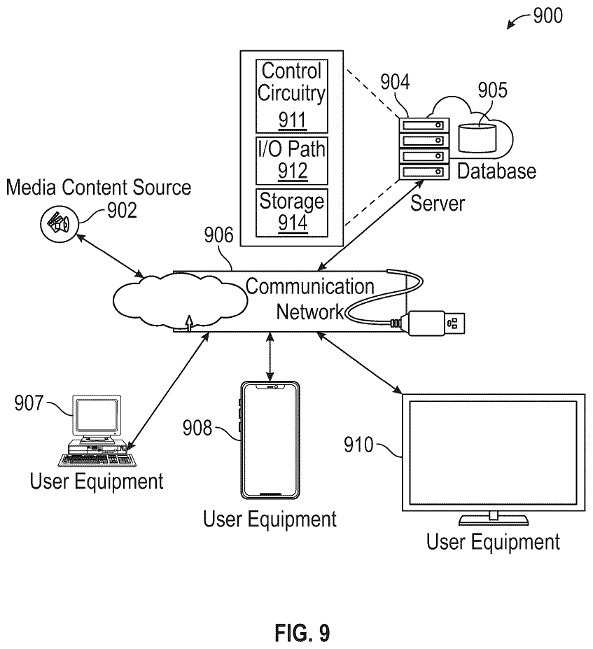

A camera application of a user device is executed using hardware components, such as the control circuitry of the user device. In some embodiments, the control circuitry of the user device is control circuitry 804 or 911, as further described in relation to FIGS. 8 and 9 below. In some embodiments, the user device executing the camera application is user equipment 907, 908 and 910 of FIG. 9. The hardware components and applications installed on the user device are managed by an operating system (OS). The control circuitry executes the functions of the camera application based on instructions stored in non-transitory memory (e.g., non-transitory memory 808 of FIG. 8). By executing the instructions, the control circuitry accesses the data provided by other applications installed on the user device. The applications installed on the user device are associated with services like Facebook™ and Snapchat™, which are provided by a server. The control circuitry accesses the applications installed on the user device by using an application programming interface (API), which is a software interface that allows for two or more applications to communicate with each other.

In some embodiments, media sharing and storage services associated with applications (e.g., Instagram, TikTok™, Facebook and Snapchat, or any suitable app), share their respective media format parameters with the native camera application on a user's device, via an API associated with the camera application that allows the media sharing and storage applications to communicate with the camera application. In some implementations, the media sharing and storage services associated with applications share their respective media format parameters with a third-party camera application on a user's device via an API associated with the third-party camera application. By using an API call to another application, the camera application retrieves the media format parameters associated with each respective media sharing and storage service. In some approaches, the media format parameters include one or more of aspect ratio, video length, exposure, lighting, video format, maximum frames, resolution, file size, shape, any other suitable parameter, or any combination thereof. In one example, the camera application receives the media format parameters from a particular media sharing and storage service in response to receiving a user-interface selection of a setting associated with the camera application.

As shown in FIG. 1A, in some embodiments, multiple media sharing and storage applications are installed on a user device 100. In some implementations, user device 100 may be one of devices 907, 908, 910 of FIG. 9. User device 100 provides user interface 102 (e.g., a touchscreen interface, mouse interface, etc.) for interacting with the media sharing and storage services associated with applications. For example, Apple iPhones™ utilizes the Apple OS, which displays icons representing applications installed on the iPhone. For example, user interface 102 includes media sharing and storage applications 106 (e.g., Instagram, TikTok, Facebook and Snapchat, or any suitable app) installed on user device 100. Each media sharing and storage application 106 of user interface 102 is associated with media format parameters 104 of a respective media sharing and storage service, which indicate the requirements for uploading media to the respective service. For example, Instagram is a service running on servers that requires a profile photo to be stored and displayed in a 320×320 resolution. Facebook is a service running on servers that requires a profile photo to be stored and displayed in 170×170 resolution. The Instagram and Facebook services are associated with respective applications that also impose these parameters on the photos uploaded to the associated servers by user device 100. In some embodiments, the media sharing and storage services associated with applications 106 communicate with user device 100 over any suitable number and/or types of suitable networks (e.g., the Internet, cellular networks, etc.). In some approaches, user device 100 communicates over communication network 906 of FIG. 9 with the servers associated with the media sharing and storage services.

In some approaches, a settings application of the OS, which is accessible via user interface 102, receives a user-interface selection of a setting 110 associated with the media format parameters for a particular media sharing and storage service represented by application 106. The operating system of user device 100 creates a user-selectable setting 110 to receive the media format parameters associated with each media sharing and storage service represented by applications 106. For example, the operating system receives a user-interface selection of setting 110 to receive the media format parameters associated with the Instagram application. Based on the received user-interface selection, camera application 108 sends API request 112 to the particular media sharing and storage application 106 to receive the media format parameters associated with the particular service of the application. In some examples, upon receiving a user-interface selection to receive the media format parameters associated with the Instagram application, camera application 108 sends an API request to the Instagram application to receive the media format parameters associated with the Instagram service. API request 112 provides machine-readable data and functionality transfer between web-based systems. Media format parameters associated with Instagram are sent (via the API) from the Instagram application to camera application 108. In some approaches, the media format parameters associated with each media sharing and storage application 106 installed on user device 100 are automatically received by the camera application 108 without requesting the media format parameters.

In some embodiments, once the media format parameters associated with the particular media sharing and storage service are received via API request 112, camera application 108 displays user-selectable icons 114, displayed by camera interface 122, for applying the media format parameters associated with the particular media sharing and storage service. For example, because the camera application 108 received a user-interface selection of setting 110 to receive the media format parameters associated with Instagram, user-selectable icon 114, represented by the Instagram logo, is generated for display at camera interface 122 of camera application 108. Based on receiving a user-interface selection of selectable icon 114, camera application 108 integrates the media format parameters associated with the selected icon into the media capturing function of the camera application. While this example displays one user-selectable icon 114 corresponding to one selected media sharing and storage application 106, it should be appreciated that camera application 108 generates for display a separate user-selectable icon 114 for each selected media sharing and storage application 106. Alternatively, media format parameters of the particular media sharing and storage application are selected without generating for display user-selectable icon 114. In some embodiments, specific media format parameters (e.g., aspect ratio, video length, exposure, lighting, video format, maximum frames, resolution, file size, or any other suitable parameter) are selected. In some embodiments media format parameters corresponding to a particular feature (e.g., profile picture, reel, story, post, cover photo, etc.) of the media sharing and storage application are selected.

In some embodiments, camera application 108, via control circuitry, generates bounding box 118, corresponding to the media format parameters (e.g., aspect ratio) of the selected media sharing and storage application, overlayed on top of viewfinder preview 116 of camera interface 122. For example, bounding box 118 may have a shape corresponding to a 9:16 aspect ratio and a size corresponding to 1080×1920 resolution, which are some of the ideal parameters for posting an Instagram Story. In some embodiments, viewfinder preview 116 analyzes sensor data from a camera component of user device 100 and displays transitory images that are stored ephemerally in transitory memory, such as random access memory (RAM). In some implementations, the transitory images displayed by viewfinder preview 116 are stored for an amount of time based on the refresh rate of the screen of user device 100. For example, most mobile devices comprise a screen that refreshes at a rate of 60 Hz to 120 Hz, or 60 to 120 frames per second. In some implementations, the images displayed by viewfinder preview 116 are permanently stored in non-transitory memory (e.g., flash or hard drive memory) when camera interface 122 receives a user-interface input to capture media. In some implementations, the image data displayed by viewfinder preview 116 is automatically stored in non-transitory memory without receiving an input, as described in further detail below.

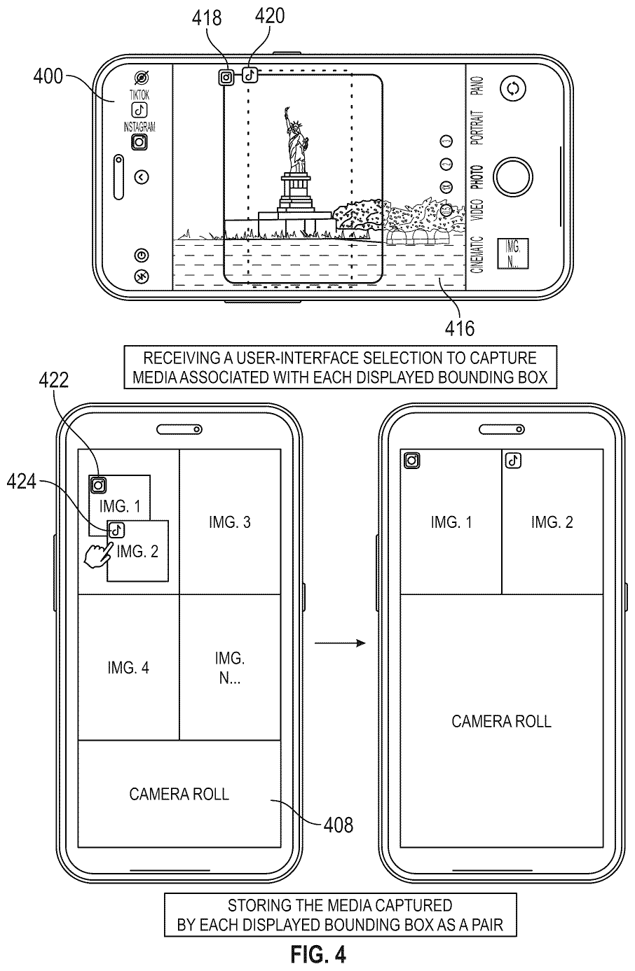

While FIG. 1A depicts one bounding box corresponding to the media format parameters of one selected media sharing and storage application, it should be appreciated that camera application 108 will generate for display a bounding box for each selected media sharing and storage application. For example, as shown in FIG. 4, if the system receives a user-interface selection to utilize the media format parameters of Instagram and TikTok, camera application 108 will simultaneously generate for display a bounding box corresponding to the aspect ratio required by Instagram and a bounding box corresponding to the aspect ratio required by TikTok.

In some approaches, camera interface 122 automatically presents bounding box 118 in a preferred position within viewfinder preview 116 based on an image analysis of the image data corresponding to a scene that the user seeks to capture and without user input. In some embodiments, camera application 108 uses machine learning models designed to automatically learn and extract hierarchical features from images. Facial recognition techniques (e.g., machine learning models), for example, compare and identify patterns in images of people to tag and verify the identity of a person. In some embodiments, the camera application 108 uses a machine learning model that accepts as input the image data corresponding to, for example, the scene of the Statue of Liberty. Based on the input, the machine learning model outputs corresponding bounding boxes in preferred positions.

In some implementations, the machine learning model is trained using historical data related to media previously uploaded to media sharing and storage services. In some embodiments, the machine learning model compares the image data within viewfinder preview 116 (or image data stored in non-transitory memory) to historical data related to media previously uploaded to a media sharing and storage service to learn which types of scenes a user typically uploads to a media sharing and storage service. In some embodiments, the machine learning model is an artificial intelligence (AI) classifier trained with a set of photos previously uploaded to a media sharing and storage service. Such a machine learning model assigns weights to a plurality of nodes or computational units. The machine learning model, for example, runs a candidate photograph through the input layer and output layer of the learning model in order to receive a confidence rating representing how similar the photograph is to previous uploads. For example, the machine learning model compares the image data of the viewfinder preview that contains the Statue of Liberty to historical data of media previously uploaded to Instagram. Camera application 108 automatically places bounding box 118 in a preferred position within viewfinder preview 116 showing the Statue of Liberty, based on the media previously uploaded to Instagram and without receiving a user input.

In some approaches, the machine learning model makes use of feature-matching algorithms, such as scale-invariant feature transform (SIFT), speeded-up robust features (SURF), or oriented FAST and rotated BRIEF (ORB), to identify distinct features within the first image as well as the image from the camera input. These algorithms detect unique points that can be reliably recognized in subsequent images, even under varying conditions of scale, orientation, or illumination.

In some embodiments, camera application 108 receives a user-interface selection to manually move bounding box 118 into a desired position. In some implementations, camera application 108 receives a user-interface input to scale or resize bounding box 118. In some approaches, camera application 108 displays a recommendation to display a bounding box corresponding to a particular media sharing and storage service, based on the image analysis of the viewfinder preview 116, without receiving a user selection of a user-selectable icon 114 corresponding to a specific media sharing and storage service. For example, camera application 108 displays a recommendation to display a bounding box corresponding to Instagram by highlighting user-selectable icon 114 corresponding to Instagram, based on the analysis of the image data within the viewfinder preview.

In some embodiments, the media format parameters associated with user-selectable icon 114 and the particular media sharing and storage service is a length of time of a video. When the media format parameter is a length of time of a video of a selected application, camera application 108 will still generate for display a bounding box corresponding to the aspect ratio required by the selected application. In some implementations, camera application 108 receives a user-interface input to begin recording a video. When the recording of the video reaches the maximum length of time permitted by the selected application, the recording is automatically stopped and the video file is stored in a non-transitory memory or network. In some implementations, camera application 108 receives a user-interface input to manually stop the recording prior to the length of time reaching the maximum permitted length. In some embodiments, camera application 108 receives a user-interface selection to record at least two separate videos for at least two different media sharing and storage services at the same time, in potentially different aspect ratios. For example, camera application 108 receives a user-interface selection to record an Instagram reel (with a maximum time of 15 minutes and an aspect ratio 9:16) and a TikTok video (with a maximum time of 10 minutes and an aspect ratio of 9:16) at the same time. In this example, camera application 108 will automatically stop the recording of the TikTok video at the 10-minute time and continue the recording of the Instagram reel until either the recording of the Instagram reel reaches the 15-minute time or camera application 108 receives a user-interface input to manually stop the recording.

As shown in FIG. 1B, in some embodiments, camera application 108 receives a user-interface input (e.g., a touch of a capture button) to capture media within bounding box 118. In some embodiments, this results in the camera application excluding any media or image data shown outside of bounding box 118, but within viewfinder preview 116. In some implementations, the media shown in bounding box 118 is automatically captured based on the image analysis described above. In some implementations, camera application 108 captures the media displayed by the entire viewfinder preview 116, not only the area shown by bounding box 118. In some approaches, camera application 108 simultaneously captures and stores both the media item displayed by bounding box 118 and the media item displayed by viewfinder preview 116 as a pair in a non-transitory memory or network storage. For example, non-transitory memory is memory/storage 808 as shown in FIG. 8. In some embodiments, camera application 108 stores metadata associated with the bounding box, such as location and the size of the bounding box, with the captured media. While the example shown by FIG. 1B is directed to one bounding box, it should be appreciated that camera application 108 may display multiple bounding boxes simultaneously for each selected media sharing and storage application installed on user device 100. For example, camera application 108 captures the media shown in each bounding box simultaneously and stores as a set any combination of the media items displayed by the bounding boxes and viewfinder preview 116. In alternative embodiments, the image data associated with the bounding box, the image data associated with the viewfinder preview and the metadata associated with a bounding box are stored separately.

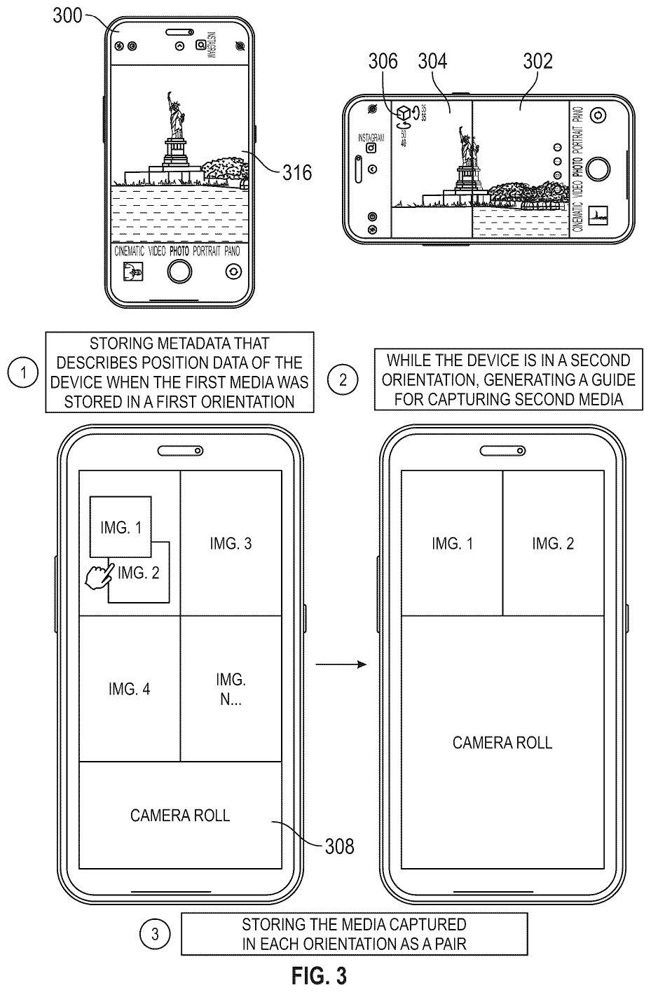

In some embodiments, camera application 108 receives a user-interface input to capture media and stores the captured media in a non-transitory memory or network storage. For example, camera application 108 captures and stores any combination of media displayed by the bounding box(es) and viewfinder preview 116. As previously mentioned, metadata associated with the bounding box and metadata associated with the respective media sharing and storage application may also be stored with the captured media in the non-transitory memory or network storage. In some embodiments, the metadata stored with the captured media is visually represented in a user's camera roll by an identifier 120 corresponding to the media format parameters (associated with the specific media sharing and storage service (e.g., Instagram)) used to capture the media. In some implementations, the metadata includes the position data associated with user device 100 at the time the media was captured, such as in FIG. 3.

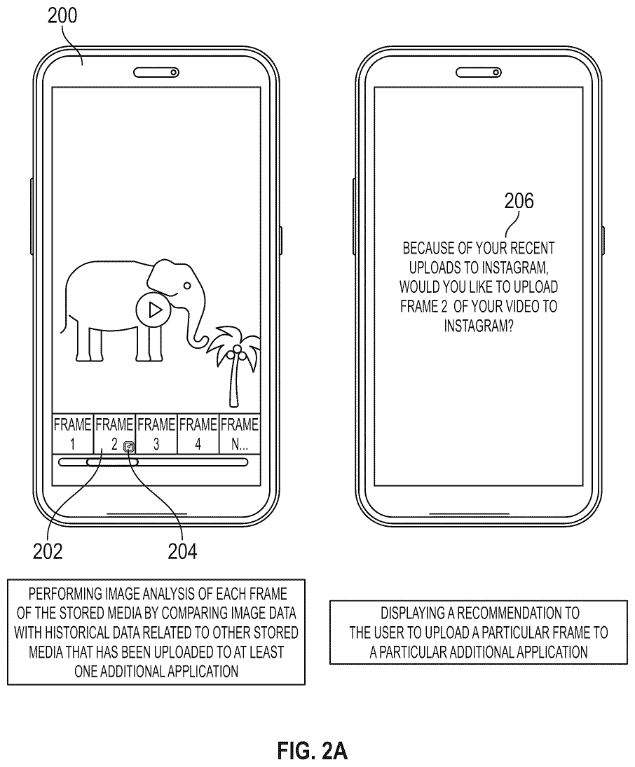

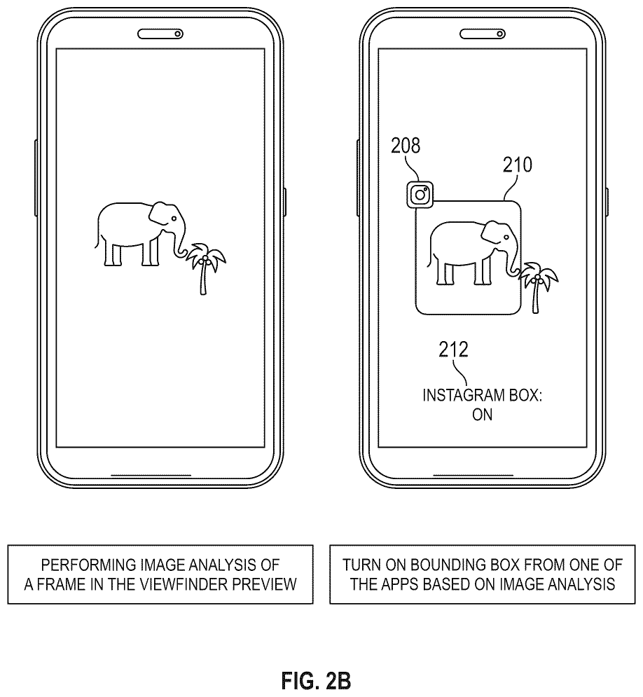

FIG. 2A is a schematic example of performing image analysis and recommending frames of a video for uploading to media sharing and storage services associated with applications, in accordance with embodiments of the disclosure.

In the example of FIG. 2A, a camera interface receives an input to begin recording video media using camera equipment associated with a user device 200. In some implementations, user device 200 is user device 100 of FIG. 1A or one of devices 907, 908, 910 of FIG. 9. In some embodiments, the camera interface is camera interface 122 of FIG. 1A. Video media may be recorded in any manner as described in reference to FIGS. 1A-1B above. For example, the camera application of user device 200 receives a user-interface input to record a video of an elephant in a forest. In some embodiments, the camera application is camera application 108 of FIG. 1A. In some embodiments, video media is recorded with or without the use of a bounding box associated with a particular media sharing and storage service, such as bounding box 118 of FIG. 1A. In some implementations, the image data of the entire viewfinder preview of the camera application is recorded as video media. In some implementations, only the image data contained in a selected bounding box is recorded as video media. In some approaches, the camera application receives a user-interface selection to record at least two separate videos for at least two different media sharing and storage services at the same time, in potentially different aspect ratios.

In some approaches, the video media captured using the camera equipment associated with user device 200 comprises a plurality of still image frames. The number of frames captured in a particular video recording is dependent upon the capture frame rate assigned to the camera equipment. For example, most mobile devices allow video media to be captured at least in 24, 30 and 60 frames per second (FPS).

In some embodiments, after the video media is recorded, the camera application stores the video media in non-transitory memory or network storage, such as flash or hard drive memory (e.g., non-transitory memory 808 of FIG. 8). In some approaches, the camera application also stores the metadata associated with a selected bounding box. In some embodiments, the camera application performs an image analysis of each frame of the plurality of frames associated with the stored video media. This is useful, for example, in cases where a user plans to use images from the video at a later time to upload to their favorite social media channels.

In some implementations, the camera application uses a machine learning model to perform the image analysis of the plurality of frames of the video media in any manner as described in reference to FIGS. 1A-1B. In some embodiments, the machine learning model analyzes metadata associated with previously uploaded media to classify certain media and track what is uploaded to various media sharing and storage services. For example, the camera application compares the image data of each frame of the video media with the data of other stored media that has been uploaded to a media sharing and storage service associated with an application installed on user device 200. For example, because a user has previously uploaded many pictures and videos to Instagram, the camera application will compare the image data of video frames to the metadata of the pictures and videos uploaded to Instagram to determine if there are any similarities. Based on the comparison, the camera application identifies a degree of similarity between the image data of each frame of the video media and the historical data of previous uploads. In some approaches, the camera application utilizes this information to recommend that certain media be uploaded to a specific media sharing and storage service. In some approaches, this process is performed by the camera application of user device 200 or by an online photo album/sharing application.

In some implementations, after the camera application performs the image analysis of the plurality of frames of the video media, the camera application marks or highlights video frame 202 with icon 204, which indicates video frame 202 as being suitable to be uploaded to a specific media sharing and storage service associated with an application installed on user device 200. In some embodiments, icon 204 is the logo of the specific media sharing and storage service. In some implementations, icon 204 is any other indicia of suitability. In some approaches, the marking or highlighting of video frame 202 with icon 204 indicates that video frame 202 is suitable to be uploaded to a certain feature of a specific media sharing and storage service. For example, based on the media format parameters (e.g., aspect ratio, resolution, orientation, etc.) associated with video frame 202, the camera application determines that video frame 202 would be suitable to be uploaded as an Instagram Story, which requires similar parameters. In some approaches, the marking or highlighting of a particular video frame may be performed in any suitable manner, such as defaulting a frame of interest to be the thumbnail for the video media.

In some embodiments, after the camera application performs the image analysis and certain frames of the video media have been marked or highlighted, the camera application displays message 206. In some implementations, message 206 recommends that a user make a user-interface selection to upload video frame 202 to a suggested media sharing and storage service, based on the image analysis. For example, because a user has previously uploaded certain media (e.g., with the same or similar media format parameters as video frame 202) to Instagram, the image analysis of video frame 202 indicates to the camera application that video frame 202 should be suggested as an upload to Instagram. In such an example, message 206 will read “Because of your recent uploads to Instagram, would you like to upload Frame 2 of your video to Instagram?” As another example, if the user is within the Instagram application and desires to post a photo currently stored in a photo library, Instagram may identify the most suitable photos in the library for posting based on the marking/highlighting.

FIG. 2B is a schematic example of performing image analysis and providing a bounding box in a preferred position for capturing media to be uploaded to media sharing and storage services associated with applications, in accordance with embodiments of the disclosure.

In the example of FIG. 2B, the image analysis described as related to FIGS. 1A-1B and 2A is performed while the image data is ephemerally stored in transitory memory, such as the random access memory (RAM) of the viewfinder preview, before the media is captured/recorded and subsequently stored in non-transitory memory (e.g., flash or hard drive memory). In some embodiments, the viewfinder preview is the viewfinder preview described in relation to FIG. 2A or viewfinder preview 116 of FIGS. 1A-1B.

In some embodiments, the camera application performs the image analysis of the image data in the viewfinder preview, using a machine learning model, in any manner as described in relation to FIGS. 1A-2A. For example, based on media previously uploaded to a social media service, a machine learning model is trained to determine what type and form of media a user typically uploads to a social media service, such as Instagram.

In some implementations, the camera application compares the image data contained in the viewfinder preview with the data of other stored media that has been uploaded to a media sharing and storage service associated with an application installed on user device 200. For example, because a user has previously uploaded many pictures and videos to Instagram, the camera application will compare the image data contained in the viewfinder preview to the metadata of the pictures and videos uploaded to Instagram to determine if there are any similarities. Based on the comparison, the camera application identifies a degree of similarity between the image data contained in the viewfinder preview and the historical data of previous uploads. In some embodiments, based on the degree of similarity between the image data contained in the viewfinder preview and the historical data of previous uploads, the camera application determines a preferred position of a bounding box to be used for capturing/recording media in certain media format parameters that are most suitable for uploading to a specific media sharing and storage service. For example, based on the media format parameters (e.g., aspect ratio, resolution, orientation, etc.) associated with previous media uploads to Instagram, the camera application determines a bounding box in a position that would be ideal for capturing/recording media to be uploaded to Instagram at a later time.

In some approaches, the camera application displays message 212, which comprises a user-selectable option to “turn on” bounding box 210. In some embodiments, bounding box 210 is automatically displayed in a preferred position without receiving a user input. In some implementations, bounding box 210 is placed in a preferred position, within the viewfinder preview, such that the subject of the viewfinder preview is captured/recorded in certain media format parameters that are most suitable for uploading to a specific media sharing and storage service. For example, if the user is wildlife photographer who uploads many pictures of animals to Instagram, the camera application will analyze the metadata of the uploaded pictures to determine the trends or preferences of the user. In this example, the camera application determines that the user prefers to upload pictures centered on animals. Using the same example, the camera application may compare this analysis to the image data associated with the scene of the elephant and the tree within the viewfinder preview of the camera application. Based on the comparison, the camera application displays bounding box 210 in a position such that only the image data associated with the elephant will be captured and stored.

In some embodiments, bounding box 210 is marked with icon 208, which indicates the specific media sharing and storage service that the displayed bounding box is associated with. In some implementations, icon 208 is the logo of the specific media sharing and storage service that was analyzed to determine the preferred position of bounding box 210. In some embodiments, icon 208 is any other suitable indicator of what data was analyzed to determine bounding box 210.

In some approaches, bounding box 210 is multiple bounding boxes corresponding to different media sharing and storage services that were analyzed to determine the preferred position of each bounding box, respectively. In this approach, each bounding box is marked with a different icon and will be associated with one of the particular media sharing and storage services that were analyzed.

FIG. 3 is a schematic example of capturing a scene in multiple orientations and storing the captured media as a pair, in accordance with embodiments of the disclosure.

In FIG. 3, in some embodiments, while user device 300 is in a first orientation, a camera application, such as camera application 108 of FIG. 1A, receives a user-interface input to store the image data displayed by viewfinder preview 316 in non-transitory memory of the user device, using the camera equipment associated with user device 300. In some implementations, user device 300 is user device 100 of FIG. 1A or one of devices 907, 908, 910 of FIG. 9. In some implementations, viewfinder preview 316 is viewfinder preview 116 of FIGS. 1A-1B. In some embodiments, the non-transitory memory is a flash or hard drive memory, such as non-transitory memory 808 of FIG. 8. Image data may be stored, for example, in any manner as described in FIGS. 1A-1B. For example, while user device 300 is in a vertical orientation, the camera application of user device 300 receives a user-interface input to store the image data of the Statue of Liberty displayed by viewfinder preview 316. In some implementations, the camera application stores comprehensive metadata from the sensors of user device 300 from the moment when the image data was stored, such as the device orientation, inertial measurements (pitch, yaw, roll), zoom level, GPS data, compass orientation, autofocus (AF) settings, and altitude. In some embodiments, the camera application stores this metadata as embedded metadata, such as exchangeable image file format (EXIF) data.

In some embodiments, user device 300 is rotated to be in a second orientation after storing the first media item. For example, user device 300 is rotated to be in a horizontal orientation after capturing and storing media associated with the Statue of Liberty while in a vertical orientation. In some implementations, the camera application detects the change in orientation and subsequently displays position guide 306 for capturing a second media item without receiving user input. In some embodiments, the camera application receives a user-interface input to display a guide for capturing a second media item. In some embodiments, position guide 306 is a semi-transparent overlay of the entirety or a portion of the first stored media item. For example, while in the horizontal orientation, the camera application of user device 300 displays semi-transparent overlay 302 of the first stored image data of the Statue of Liberty while viewfinder preview 316 concurrently displays image data 304 corresponding to the electrical signal received by the camera sensor of user device 300. In some implementations, the camera application determines the tint of semi-transparent overlay 302 based on instructions stored in the non-transitory memory based on color theory. In some implementations, position guide 306 is an overlay of a representation of the stored position data of the first media item, such as compass direction (heading), pitch, roll, and yaw and the current position data of user device 300. For example, the camera application of user device 300 displays position guide 306, which includes a 3D representation of user device 300 as a cube, a numerical representation of the stored position data of the first stored image of the Statue of Liberty in black, and a numerical representation of the current position data of user device 300. In some embodiments, position guide 306 is displayed in various colors (e.g., yellow and green), where the colors indicate the degree in which the current position data is within a range required for proper alignment. In some approaches, the camera application sets a zoom level based on the zoom level that was used when the first media item was captured and stored.

In some embodiments, the camera application uses a feature-matching algorithm, such as scale-invariant feature transform (SIFT), speeded-up robust features (SURF) or oriented FAST and rotated BRIEF (ORB), to identify distinct features within the image data of the stored first media item as well as from image data 304. In some implementations, the camera application continuously analyzes image data 304 by a feature-matching algorithm and displays a guide for capturing the second media item based on the analysis. In some implementations, position guide 306 is an overlay of a visual indicator of a coarse corrective measure to be taken. For example, the camera application displays a large arrow overlaying viewfinder preview 316, indicating a direction in which user device 300 should be moved. It should be appreciated that the camera application may use any combination of the disclosed techniques to generate a guide for capturing the second media item. For example, the camera application will continuously analyze image data 304 in viewfinder preview 316 by using a feature matching algorithm, display an overlay of a visual indicator of a coarse corrective measure to be taken, and display an overlay of a representation of the stored position data of the first media item with the current position data of user device 300.

In some embodiments, while user device 300 is in the second orientation, the camera application receives a user-interface input to store image data 304 displayed by viewfinder preview 316 in non-transitory memory of the user device using camera equipment associated with user device 300. In some implementations, the camera application determines image data 304 and semi-transparent overlay 302 are sufficiently aligned and subsequently stores image data 304 as a second media item without user input. In some implementations, the camera application determines that current position data of user device 300 is within a range of the stored position data of the first media item required for proper alignment and subsequently stores image data 304 as a second media item without user input. In some embodiments, the camera application determines by the feature matching algorithm that image data 304 is aligned with the stored first media item and subsequently stores image data 304 as a second media item without user input. It should be appreciated that the camera application may use any combination of disclosed methods for determining proper alignment and subsequently store image data 304 as a second media item without user input. In some implementations, the camera application determines image data 304 is properly aligned with the stored first media item and subsequently displays a recommendation to store the second media item. For example, the camera application may display a recommendation to store the second media item by displaying a symbol indicative of proper alignment, such as a checkmark or green light.

In some embodiments, the camera application stores the first and second media items as a pair. In some approaches, the second media item is stored with metadata that includes a reference identifier of the first media. In some approaches, metadata that includes a reference identifier of the second media item is added to the first media item. In some embodiments, the camera application stores the first and second media items with metadata such that a bi-directional relationship between the two media items is maintained. For example, the camera application displays the first media item and second media item as a pair within camera roll 308. In some embodiments, the first and second media items are uploaded to a particular media sharing and storage service as a pair. In some implementations, the first media item of the paired media items is displayed on a viewing device when the orientation of the viewing device is in the same orientation that user device 300 was in when the first media item was stored. In some approaches, the viewing device is a different device from user device 300. In some implementations, the second media item of the paired media items is displayed on a viewing device when the orientation of the viewing device is the same as the orientation user device 300 was when the second media item was stored. For example, when user device 300 is displaying the stored media item while in a vertical position, the first stored media item is displayed. In some embodiments, retrieving and displaying a secondary version of an image, instead of a primary version of an image, while the user device is positioned in a certain orientation, is called the “special browsing mode.” In some implementations, the particular displayed media item of the paired media items will change based on shifts in the orientation of the viewing device. For example, when user device 300 displays the first stored media item while in a vertical direction and is shifted to be in a horizontal orientation, user device 300 will stop displaying the first stored media item and begin displaying the second stored media item. It should be appreciated that a guide may be generated for storing any number of additional media items and that any number of media items may be stored as a group.

In some approaches, the camera application prefetches stored content. In some embodiments, the camera application detects a user-interface input to scroll through stored content in a particular direction. The camera application prefetches the stored content in response to determining the direction of the scrolling. For example, a camera roll stores a plurality of images that may be browsed by a user. If the user is browsing through the camera roll (in a specific direction) while the user device is in a horizontal orientation, the camera application will prefetch the horizontal content in the direction of the scrolling. In some implementations, this prefetching is performed by a media sharing and storage application installed on a user device.

FIG. 4 is a schematic example of capturing a scene using multiple media format parameters and storing the captured media items as a pair, in accordance with embodiments of the disclosure.

In FIG. 4, in some embodiments, a camera application, such as camera application 108 of FIG. 1A, of user device 400 overlays bounding box 418, associated with a first particular media sharing and storage service, and bounding box 420, associated with a second particular media sharing and storage service, over viewfinder preview 416. In some implementations, user device 400 is user device 100 of FIG. 1A, user device 300 of FIG. 3 or one of devices 907, 908, 910 of FIG. 9. In some implementations, viewfinder preview 416 is viewfinder preview 116 of FIGS. 1A-1B, and bounding box 418 is bounding box 118 of FIGS. 1A-1B. For example, the camera application of user device 400 displays bounding box 418, associated with the Instagram media sharing and storage service, and bounding box 420, associated with the TikTok media sharing and storage service. In some embodiments, the camera application displays bounding box 418 and bounding box 420 based on receiving a user-interface input. In some embodiments, the camera application displays bounding box 418 and bounding box 420 based on image analysis of the viewfinder preview and without receiving a user-interface input, as discussed above in reference to FIGS. 1A-1B. It should be appreciated that the camera application may display any number of bounding boxes associated with selected media sharing and storage services.

In some implementations, the camera application receives a user-interface input to store a first media item corresponding to the image data displayed within bounding box 418 and a second media item corresponding to the image data displayed within bounding box 420, in non-transitory memory of user device 400. For example, the camera application of user device 400 receives a user-interface input to store a first media item corresponding to the image data displayed within bounding box 418, associated with the Instagram service, and a second media item corresponding to the image data displayed within bounding box 420, associated with the TikTok service. In some approaches, the camera application additionally stores the image data displayed by the entirety of the viewfinder preview 416 in non-transitory memory of user device 400. In some embodiments, image data is stored in any manner as described in FIGS. 1A and 3. It should be appreciated that the camera application may store any number or combination of media items associated with displayed bounding boxes.

In some implementations, the camera application stores the first media item with the metadata corresponding to the first particular media sharing and storage service and stores the second media item with the metadata corresponding to the second particular media sharing and storage service. In some embodiments, the camera application stores the first and second media items as a pair. In some approaches, the second media item is stored with metadata that includes a reference identifier of the first media item. In some approaches, the first media item is stored with metadata that includes a reference identifier of the second media item. In some embodiments, the first and second media items are stored with metadata that includes a particular group identifier to pair the images. In some embodiments, the camera application stores the first and second media items with the respective metadata such that a bi-directional relationship between the two media items is maintained. In some implementations, the camera application displays the first media and second media items as a pair within camera roll 408. In some implementations, the camera application displays a service identifier, such as service identifier 422 or service identifier 424, corresponding to the particular media sharing and storage service of the bounding box the image data was displayed within. For example, the camera application displays the first media item that was displayed within bounding box 418 (associated with the Instagram service), with service identifier 422 (e.g., the Instagram logo), and second media item that was displayed within bounding box 420 (associated with the TikTok service), with service identifier 424 (e.g., the TikTok logo), as a pair within camera roll 308. It should be appreciated that the camera application may store any number of media items as a group and may display a respective service identifier corresponding to the particular media sharing and storage service of the bounding box the image data was displayed within for each stored media item.

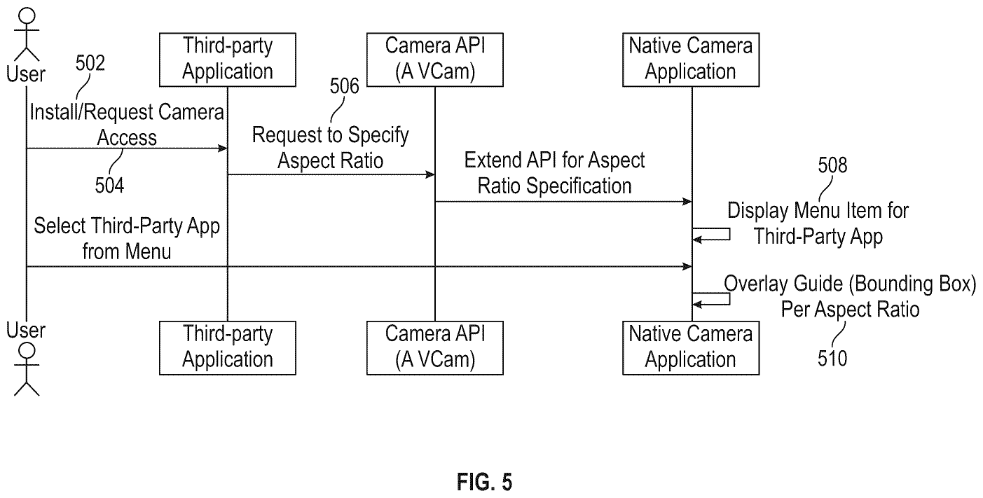

FIG. 5 is a flow diagram of sending an API request and receiving media format parameters in response, in accordance with embodiments of the disclosure.

In the example of FIG. 5, a camera application extends its API to allow third-party applications to communicate their desired media format parameters. In some embodiments, this process begins with receiving user-interface input 502 to install a third-party application associated with a media sharing and storage service. In some approaches, this process begins with camera application request 504 for the media format parameters desired by a media sharing and storage service associated with a third-party application installed on the user device. In some embodiments, the API request is made in any manner as described in FIGS. 1A-1B.

In some implementations, the third-party applications are media sharing and storage applications 106 as described in FIG. 1A. In some embodiments, the camera application is camera application 108 as described in FIG. 1A. In some implementations, the media format parameters are media format parameters 104 as described in FIG. 1A (e.g., aspect ratio, video length, exposure, lighting, video format, maximum frames, resolution, file size, or any other suitable parameter). In some approaches, the user device is user device 100 as described in FIGS. 1A-1B.

In some embodiments, when the third-party application is installed onto the user device or when a request for the media format parameters associated with the third-party application is made, a permissions request to allow for the specification 506 of the desired media format parameters is also included. For example, upon receiving a user-interface selection to receive the media format parameters associated with the Instagram application, the camera application sends an API request to the Instagram application to specify the media format parameters associated with the Instagram service. While the example provided by FIG. 5 depicts extending a camera application's API to receive a specification of a certain aspect ratio required by the associated third-party application, it should be appreciated that the camera application's API may be extended to receive a specification of any media format parameter or multiple different media format parameters.

In some embodiments, once the media format parameters associated with the third-party application are received via the API extended by the camera application, the camera application displays user-selectable menu item 508, displayed on the camera interface, for applying the media format parameters required by the particular media sharing and storage service associated with the third-party application that was given permission. For example, because the camera application received a user-interface input to receive the media format parameters associated with Instagram, user-selectable menu item 508, represented by the Instagram logo, is generated for display at the camera interface of the camera application. Based on receiving a user-interface selection of user-selectable menu item 508, the camera application integrates the media format parameters associated with the selected menu item into the camera interface. In some implementations, user-selectable menu item 508 is the same as user-selectable icon 114 as further described in FIG. 1A. In some approaches, the camera interface is camera interface 122 as further described in FIG. 1A. While the example provided by FIG. 5 depicts one user-selectable menu item 508 corresponding to one selected media sharing and storage application, it should be appreciated that the camera application generates for display a separate user-selectable menu item 508 that corresponds to the media format parameters requested from each media sharing and storage application that was granted permission.

In some embodiments, in response to receiving a user-interface selection of user-selectable menu item 508, which corresponds to the media format parameters of a third-party application installed on the user device, the camera application generates for display bounding box 510 via the camera interface. In some implementations, bounding box 510 is bounding box 118 as further described in FIGS. 1A-1B. In some approaches, bounding box 510 represents the aspect ratio of the media sharing and storage service associated with the selected menu item 508. In some implementations, bounding box 510 represents any other suitable media format parameter. In some embodiments, bounding box 510 overlays the viewfinder preview of the camera interface, such that a camera application assists a user in capturing media that aligns with the media format parameters preferred by the selected media sharing and storage service.

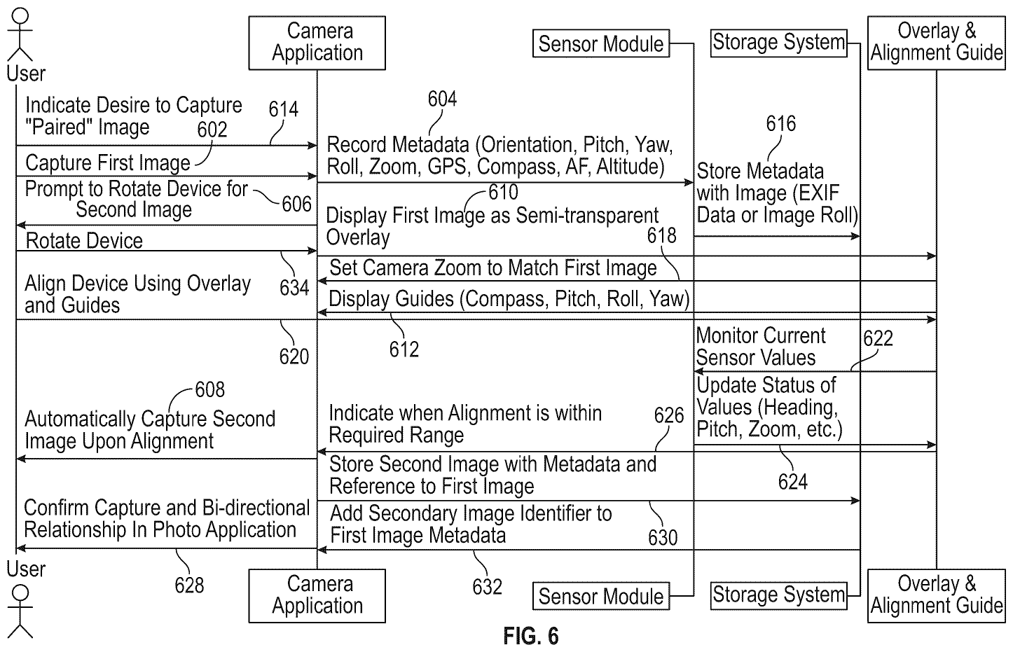

FIG. 6 is a flow diagram of capturing a scene in multiple orientations and storing the captured media as a pair, in accordance with embodiments of the disclosure.

In some embodiments, the example process depicted by FIG. 6 is the same process described in more detail in reference to FIGS. 3-4. In the example provided by FIG. 6, at step 614, a camera application receives a user-interface input indicating a desire to store a “paired image” of a scene. In some approaches, media may be captured in any manner as described in FIGS. 1-4. In some embodiments, the camera application is camera application 108 as described in FIG. 1A. In some implementations, the paired images are the same pair of images of the scene described in FIG. 3 (e.g., a first media item captured in a first orientation is stored together with a second media item captured in a different orientation, where both the first media item and the second media item capture the same target area of a viewfinder preview). In some approaches, the viewfinder preview is viewfinder preview 116 of FIGS. 1A-1B.

In some embodiments, the camera application receives a user-interface input to capture first media item 602 in a first orientation. For example, while the user device is in a vertical orientation, the camera application of the user device receives a user-interface input to store the image data of the Statue of Liberty displayed by the viewfinder preview of the camera interface. In some embodiments, the user device is user device 100 of FIG. 1A or one of devices 907, 908, 910 of FIG. 9 and the camera interface is camera interface 122 as further described in FIGS. 1A-1B.

In some embodiments, during the initial capturing of first media item 602, the camera application records comprehensive metadata 604 from the sensors of the user device. In some approaches, metadata 604 includes data such as device orientation, inertial measurements (pitch, yaw, roll), zoom level, GPS data, compass orientation, autofocus (AF) settings, and altitude. In some embodiments, at step 616, the camera application stores metadata 604 as embedded metadata such as exchangeable image file format (EXIF) data. In some implementations, metadata 604 is used to properly align the user device such that different media items of the same target area are captured.

In some embodiments, first media 602 is stored in a non-transitory memory of the user device using camera equipment associated with the user device. In some embodiments, the non-transitory memory is a flash or hard drive memory, such as non-transitory memory 808 of FIG. 8. Additionally, image data may be stored in any manner as described in FIGS. 1-4.

In some approaches, the camera application receives a user-interface input to capture second media item 608 in a second orientation that is different from the first orientation. For example, at step 634, the user device is rotated into a horizontal orientation after capturing and storing first media item 602 associated with the Statue of Liberty while in a vertical orientation. In some embodiments, at step 606, the camera application displays a prompt instructing the user to rotate the user device for capturing second media item 608.

In some implementations, to assist the user in capturing the same target area of a viewfinder preview in a different orientation, at step 618, the camera application generates for display a guide 612 in the viewfinder preview, which includes semi-transparent overlay 610. In some embodiments, semi-transparent overlay 610 is the same as semi-transparent overlay 302 as described in further detail in FIG. 3. For example, semi-transparent overlay 610 is a semi-transparent copy of first media item 602 associated with the Statue of Liberty displayed in the viewfinder preview, captured while the user device is in the vertical orientation. In some implementations, semi-transparent overlay 610 depicts first media item 602 in its entirety. In some approaches semi-transparent overlay 610 partially depicts first media item 602. In some approaches, at step 620, semi-transparent overlay 610 allows the viewfinder preview for capturing second media item 608 to be manually aligned with the orientation and properties (e.g., inertial measurements (pitch, yaw, roll), zoom level, GPS data, compass orientation, autofocus (AF) settings, and altitude) associated with the capturing of first media item 602.

In some embodiments, guide 612 includes a compass to match the orientation and properties associated with the capturing of first media item 602, without displaying semi-transparent overlay 610. In some approaches, the compass and semi-transparent overlay 610 are displayed simultaneously. In some implementations, guide 612 is the same as position guide 306 of FIG. 3. In some embodiments, the compass includes numerical values associated with the properties, such that the viewfinder preview indicates a degree to which the user device should be adjusted to properly align with first media item 602. In some approaches, at step 622, as the user device is manipulated to align the viewfinder preview of second media item 608 with the orientation and properties associated with the capturing of first media item 602, the camera application monitors the change in the properties as indicated by the sensors of the camera equipment. In some embodiments, at step 624, when a change in the properties is detected, the camera application updates the numerical values associated with the properties, to adjust the degree indicating how much more movement is necessary in order to properly align. For example, as the user device is physically moved, the pitch, yaw and roll of the device will change, and the numerical values associated with these properties will be updated in guide 612 to reflect the change. In this way, for example, the viewfinder preview indicates the degree of additional movement of these properties (i.e., pitch, yaw and roll, etc.) that is needed in order to properly align with the first media item captured of the Statue of Liberty.

In some approaches, the camera application determines that the alignment is within a sufficient range and captures second media item 608 in any manner as described in FIGS. 3-4. In some embodiments, at step 626, sufficient alignment is indicated in any manner as described in FIG. 3.

In some implementations, at step 630, the camera application stores first media item 602 and second media item 608 as a pair in a camera roll. In some embodiments, first media item 602 and second media item 608 are stored in any manner as previously described in FIG. 3 or 4. For example, at step 632, metadata that includes a reference identifier of second media item 608 is added to first media item 602, such that a bi-directional relationship between the two media items is maintained. In some approaches, at step 628, the camera application confirms the capturing of second media item 608 and that it is in a bi-directional relationship with other stored media.

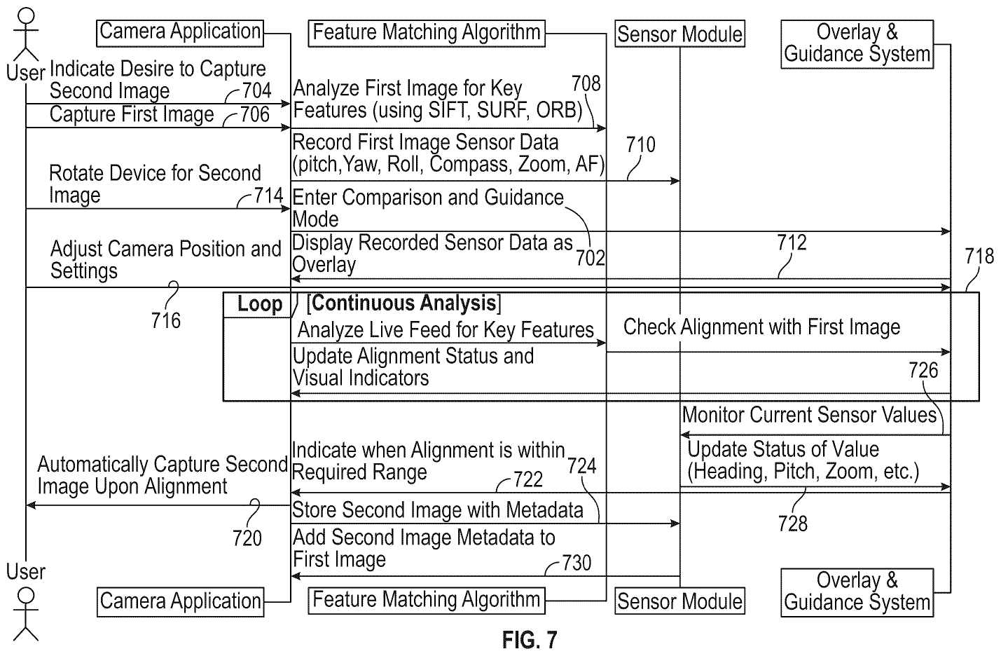

FIG. 7 is a flow diagram of capturing a scene in multiple orientations and storing the captured media items as a pair, in accordance with embodiments of the disclosure.

In some embodiments, at step 704, a camera application receives a user-interface input to capture first media in a first orientation. In some approaches, at step 706, media may be captured in any manner as described in relation to FIGS. 1-4. In some embodiments, at step 708, the camera application makes use of the feature matching algorithms, explained in further detail as related to FIGS. 1-3, to identify distinct features within a first captured media item that can be reliably recognized in subsequently captured media, even under varying conditions such as scale, orientation, or illumination. In some approaches, the camera application is camera application 108 as described in relation to FIG. 1A. In some embodiments, the first captured media is first media item 602 as further described in reference to FIG. 6.

In some implementations, at step 714, the camera application displays a prompt instructing the user to rotate its device for capturing subsequent media. In some embodiments, the subsequent media is second media item 608 as further described in reference to FIG. 6. In some approaches, when the camera application displays the prompt, the camera interface of the camera application enters comparison and guidance mode 702. In some embodiments, the camera interface is camera interface 122 as further described in reference to FIGS. 1A-1B. In some approaches, while in comparison and guidance mode 702, at step 718, the camera application monitors the live media feed of the viewfinder preview, in real time, using the feature matching algorithms, to search for key features identified in the first captured media item. In some implementations, the viewfinder preview is viewfinder preview 116 as described in further detail in reference to FIGS. 1A-1B. In some embodiments, the camera application monitors the live media feed of the viewfinder preview in any manner as described in reference to FIG. 6. For example, the camera application monitors the change in the properties as indicated by the sensors of the camera equipment. In some embodiments, at step 710, the image sensor data identified in the first captured media item is the orientation and properties (e.g., inertial measurements (pitch, yaw, roll), zoom level, GPS data, compass orientation, autofocus (AF) settings, and altitude) associated with the first captured media as described in reference to FIGS. 3 and 6. In some approaches, at step 712, the image data describing the identified key features is displayed as an overlay via the camera interface.

In some embodiments, comparison and guidance mode 702 includes semi-transparent overlay 610 or 302 and guide 610, which assist the user in capturing the same target area of a viewfinder preview in a different orientation and are described in further detail in reference to FIGS. 3 and 6. In some approaches, at step 726, the camera application continuously monitors the live media feed of the viewfinder preview for capturing the subsequent media as the user device is adjusted to align with the orientation and properties associated with the first captured media. In some implementations, at step 728, the camera application tracks the changes in the orientation and properties of the user device as it is adjusted and updates the semi-transparent overlay and/or guide to reflect these changes. For example, if the first captured image was captured with a specific pitch and roll, the camera application detects the change in the movement of the user device to match these angles. Similarly, the compass heading of the guide and zoom level are replicated to ensure the same directional orientation and framing.

In some embodiments, the semi-transparent overlay and/or guide is presented and the camera application continues to monitor and update the semi-transparent overlay and guide until the parameters of the viewfinder preview associated with the capturing of the subsequent media closely align with those of the first captured media. In some approaches, the semi-transparent overlay and/or guide is removed when sufficiently close alignment is achieved. In some implementations, if the properties of the viewfinder preview associated with the capturing of the subsequent media are determined to be substantively out of range when compared to the values of the first captured media, the camera application displays a visual indicator to the user indicating a corrective measure for better alignment. For example, the camera application displays a large arrow (or some other suitable indicator) indicating that the user device should be adjusted in a certain direction.

In some implementations, at step 720, the camera application determines that the alignment is within a sufficient range and captures the subsequent media item in any manner as described in relation to FIGS. 3-4. In some embodiments, at step 722, sufficient alignment is indicated in any manner as described in relation to FIG. 3. In some embodiments, at steps 724 and 730, the first captured media item and the subsequent media item are stored together as a pair in any manner as previously described in relation to FIG. 3 or 4.

FIGS. 8-9 describe exemplary devices, systems, servers, and related hardware for capturing media in accordance with the media format parameters associated with media sharing and storage services, in accordance with some embodiments of this disclosure.

FIG. 8 shows generalized embodiments of illustrative user equipment devices 800 and 801. For example, user equipment device 800 may be a smartphone device (e.g., user device 100 of FIG. 1). In another example, user equipment system 801 may be a user television equipment system. User television equipment system 801 may include set-top box 816. Set-top box 816 may be communicatively connected to microphone 818, speaker 814, and display 812. In some embodiments, microphone 818 may receive voice commands for a media or camera application. In some embodiments, display 812 may be a television display or a computer display. In some embodiments, set-top box 816 may be communicatively connected to user input interface 810. In some embodiments, user input interface 810 may be a remote control device. Set-top box 816 may include one or more circuit boards. In some embodiments, the circuit boards may include processing circuitry, control circuitry, and storage (e.g., RAM, ROM, Hard Disk, Removable Disk, etc.). In some embodiments, the circuit boards may include an input/output path. More specific implementations of user equipment devices are discussed below in connection with FIG. 8. Each one of user equipment device 800 and user equipment system 801 may receive content and data via input/output (“I/O”) path 802. I/O path 802 may provide content (e.g., broadcast programming, on-demand programming, Internet content, content available over a local area network (LAN) or wide area network (WAN), and/or other content) and data to control circuitry 804, which includes processing circuitry 806 and storage 808. Storage 808 comprises the instructions for the camera application to perform the steps of FIGS. 1-7, when executed by processing circuitry 806. Control circuitry 804 may be used to send and receive commands, requests, and other suitable data using I/O path 802, which may comprise I/O circuitry. I/O path 802 may connect control circuitry 804 (and specifically processing circuitry 806) to one or more communications paths (described below). I/O functions may be provided by one or more of these communications paths, but are shown as a single path in FIG. 8 to avoid overcomplicating the drawing.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for a camera application stored in memory (i.e., storage 808). Specifically, control circuitry 804 may be instructed by the camera application to perform the functions discussed above and below. In some implementations, any action performed by control circuitry 804 may be based on instructions received from the camera application.

In client/server-based embodiments, control circuitry 804 may include communications circuitry suitable for communicating with a media application server or other networks or servers. The instructions for carrying out the above-mentioned functionality may be stored on a server (which is described in more detail in connection with FIG. 9. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 9). In addition, communications circuitry may include circuitry that enables peer-to-peer communication of user equipment devices, or communication of user equipment devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as camera application data described above. Nonvolatile memory may also be used (e.g., to launch a boot-up routine and other instructions). Cloud-based storage, described in relation to FIG. 9, may be used to supplement storage 808 or instead of storage 808.

Control circuitry 804 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 804 may also include scaler circuitry for upconverting and downconverting content into the preferred output format of user equipment 800. Circuitry 804 may also include digital-to-analog converter circuitry and analog-to-digital converter circuitry for converting between digital and analog signals. The tuning and encoding circuitry may be used by user equipment device 800, 801 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from user equipment device 800, the tuning and encoding circuitry (including multiple tuners) may be associated with storage 808.

A user may send instructions to control circuitry 804 using user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of user equipment device 800 and user equipment system 801. For example, display 812 may be a touchscreen or touch-sensitive display. In such circumstances, user input interface 810 may be integrated with or combined with display 812. Display 812 may be one or more of a monitor, a television, a display for a mobile device, or any other type of display. A video card or graphics card may generate the output to display 812. The video card may be any processing circuitry described above in relation to control circuitry 804. The video card may be integrated with the control circuitry 804. Speakers 814 may be provided as integrated with other elements of each one of user equipment device 800 and user equipment system 801 or may be stand-alone units. The audio component of videos and other content displayed on display 812 may be played through the speakers 814. In some embodiments, the audio may be distributed to a receiver (not shown), which processes and outputs the audio via speakers 814.

The camera application may be implemented using any suitable architecture. For example, it may be a stand-alone application wholly-implemented on each one of user equipment device 800 and user equipment system 801. In such an approach, instructions of the application are stored locally (e.g., in storage 808), and data for use by the application is downloaded on a periodic basis (e.g., from an out-of-band feed, from an Internet resource, or using another suitable approach). Control circuitry 804 may retrieve instructions of the application from storage 808 and process the instructions to rearrange the segments as discussed. Based on the processed instructions, control circuitry 804 may determine what action to perform when input is received from user input interface 810. For example, movement of a cursor on a display up/down may be indicated by the processed instructions when user input interface 810 indicates that an up/down button was selected.

In some embodiments, the media application is a client/server-based application. Data for use by a thick or thin client implemented on each one of user equipment device 800 and user equipment system 801 is retrieved on-demand by issuing requests to a server remote to each one of user equipment device 800 and user equipment system 801. In one example of a client/server-based guidance application, control circuitry 804 runs a web browser that interprets web pages provided by a remote server. For example, the remote server may store the instructions for the application in a storage device. The remote server may process the stored instructions using circuitry (e.g., control circuitry 804) to perform the operations discussed in connection with FIGS. 1-7 and 10-11.

In some embodiments, the camera application may be downloaded and interpreted or otherwise run by an interpreter or virtual machine (run by control circuitry 804). In some embodiments, the camera application may be encoded in the ETV Binary Interchange Format (EBIF), received by the control circuitry 804 as part of a suitable feed, and interpreted by a user agent running on control circuitry 804. For example, the camera application may be an EBIF application. In some embodiments, the camera application may be defined by a series of JAVA-based files that are received and run by a local virtual machine or other suitable middleware executed by control circuitry 804. In some of such embodiments (e.g., those employing MPEG-2 or other digital media encoding schemes), the media application may be, for example, encoded and transmitted in an MPEG-2 object carousel with the MPEG audio and video packets of a program.

FIG. 9 shows illustrative devices and systems for capturing media in accordance with the media format parameters associated with media sharing and storage services, in accordance with some embodiments of this disclosure. User equipment devices 907, 908, 910 (e.g., user device 100) may be coupled to communication network 906. Communication network 906 may be one or more networks including the Internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 906) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 906.

System 900 includes a media content source 902 and a server 904, which may comprise or be associated with database 905. Communications with media content source 902 and server 904 may be exchanged over one or more communications paths but are shown as a single path in FIG. 9 to avoid overcomplicating the drawing. In addition, there may be more than one of each of media content source 902 and server 904, but only one of each is shown in FIG. 9 to avoid overcomplicating the drawing. If desired, media content source 902 and server 904 may be integrated as one source device.

In some embodiments, server 904 may include control circuitry 911 and a storage 914 (e.g., RAM, ROM, Hard Disk, Removable Disk, etc.). Server 904 may also include an input/output path 912. I/O path 912 may provide device information, or other data, over a local area network (LAN) or wide area network (WAN), and/or other content and data to the control circuitry 911, which includes processing circuitry, and storage 914. The control circuitry 911 may be used to send and receive commands, requests, and other suitable data using I/O path 912, which may comprise I/O circuitry. I/O path 912 may connect control circuitry 904 (and specifically processing circuitry) to one or more communications paths.

Control circuitry 911 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 911 executes instructions for an emulation system application stored in memory (e.g., the storage 914). Memory may be an electronic storage device provided as storage 914 that is part of control circuitry 911.

Server 904 may retrieve guidance data from media content source 902, process the data as will be described in detail below, and forward the data to user equipment devices 907, 908 and 910. Media content source 902 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 902 may be the originator of content (e.g., a television broadcaster, a Webcast provider, etc.) or may not be the originator of content (e.g., an on-demand content provider, an Internet provider of content of broadcast programs for downloading, etc.). Media content source 902 may include cable sources, satellite providers, on-demand providers, Internet providers, over-the-top content providers, or other providers of content. Media content source 902 may also include a remote media server used to store different types of content (including video content selected by a user), in a location remote from any of the client devices. Media content source 902 may also provide metadata that can be used to identify important segments of media content as described above.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 904), which may be located centrally or at distributed locations, that provide cloud-based services to various types of users and devices connected via a network such as the Internet via communication network 906. In such embodiments, user equipment devices may operate in a peer-to-peer manner without communicating with a central server.

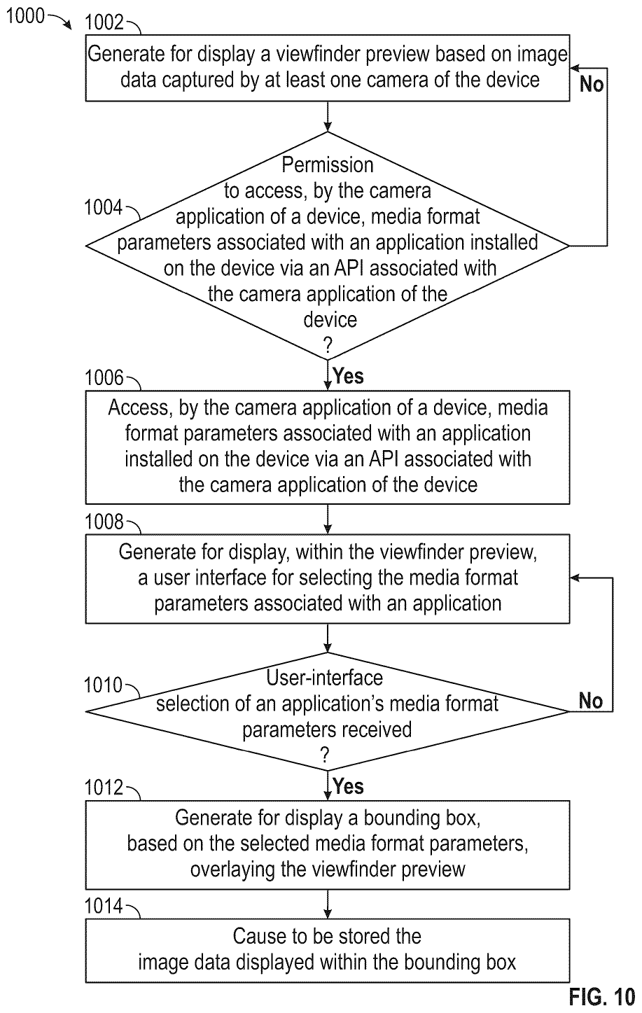

FIG. 10 is flowchart of a detailed illustrative process for capturing media in accordance with the media format parameters associated with media sharing and storage services, in accordance with some embodiments of this disclosure. In various embodiments, the individual steps of process 1000 may be implemented by one or more components of the devices and applications of FIGS. 1-10. Although the present disclosure may describe certain steps of process 1000 (and of other processes described herein) as being implemented by certain components of the devices and applications of FIGS. 1-10, this is for purposes of illustration only, and it should be understood that other components of the devices and systems of FIGS. 1-10 may implement those steps instead.

Process 1000 begins at step 1002, where a camera application (e.g., camera application 108 as described in relation to FIGS. 1A-1B) of a user device (e.g., user equipment 907, 908 and 910 of FIG. 9) generates for display via a control circuitry (e.g., control circuitry 804 of FIG. 8) a viewfinder preview based on image data captured by at least one camera of the user device. In some approaches, the viewfinder preview is viewfinder preview 116 or 316 of FIGS. 1 and 3, respectively. In some implementations, the user device is user device 100, 300, or 400 of FIGS. 1, 3, and 4, respectively.

At step 1004, the camera application, via the control circuitry executing the camera application described in FIGS. 1A-4 (e.g., control circuitry 806), determines if it has permission to access the media format parameters associated with an application installed on the user device via an API associated with the camera application of the device. In some embodiments, the API associated with the camera application is API request 112 as further described in reference to FIGS. 1A-1B. In some approaches, the operating system of the user device controls the permissions of the camera application to access media format parameters associated with an application. In some implementations, the camera application or installed application, via the control circuitry, controls the permissions of the camera application to access media format parameters associated with an application. In some embodiments, permissions to access media format parameters associated with an application may be set by user selections, as described in reference to FIGS. 1A-1B. In response to determining that the camera application does not have permission to access the media format parameters associated with an application installed on the user device, process 1000 returns to step 1002 and the camera application continues to generate for display the viewfinder preview. In response to determining that the camera application does have permission to access the media format parameters associated with an application installed on the user device, process 1000 proceeds to step 1006.

At step 1006, the camera application accesses the media format parameters associated with an application installed on the user device via an API associated with the camera application of the device. In some embodiments, the camera application will access the media format parameters associated with an application that it has permission to access. In some implementations, the camera application will access the media format parameters associated with all of the applications that have granted permissions. In some approaches, the camera application accesses the media format parameters associated with an application installed on the user device as further described in reference to FIGS. 1A-1B.

At step 1008, the camera application, via the control circuitry, generates for display, within the viewfinder preview, a user interface for selecting the media format parameters associated with an application. In some approaches, the user interface for selecting the media format parameters will contain user-interface selection options for each application for which the camera application accessed the associated media format parameters. In some embodiments, the user interface for selecting the media format parameters is user interface 102 as described in reference to FIGS. 1A-1B.

At step 1010, the camera application determines, via the control circuitry, if a user-interface selection of an application's media format parameters has been received. In response to determining that a user-interface selection of an application's media format parameters has not been received, process 1000 returns to step 1008, and the camera application continues to display the user interface for selecting the media format parameters associated with an application. In response to determining that a user-interface selection of an application's media format parameters has been received, process 1000 proceeds to step 1012.

At step 1012, the camera application, via the control circuitry, generates for display a bounding box based on the selected media format parameters, which overlays the viewfinder preview. In some approaches, the camera application generates for display a bounding box for each selected application's media format parameters. In some implementations the bounding box is bounding box 118, 418, or 420 of FIGS. 1 and 4 respectively. In some approaches the bounding box is generated for display in a preferred position within the viewfinder preview based on image analysis, as further described in reference to FIG. 1A.

At step 1014, the camera application, via the control circuitry, causes to be stored the image data displayed within the bounding box. In some approaches, the image data is stored in non-transitory memory (e.g., non-transitory memory 808 of FIG. 8) or network storage. In some embodiments, the camera application causes to be stored the image data based on a received user-interface input. In some embodiments, the camera application causes to be stored the image data based on image analysis as described in reference to FIGS. 1A-1B. In some approaches, the camera application causes to be stored the image data displayed within the bounding box and does not store the image data displayed outside of the bounding box. In some approaches, the camera application causes to be stored the image data displayed by the entirety of the viewfinder, including the image data within the bounding box, and metadata corresponding to the size and location of the bounding box. In some approaches, the camera application causes to be stored the image data displayed within multiple bounding boxes. In some embodiments, the image data is stored by the camera equipment of the user device and stored in any manner as further described in reference to FIGS. 1 and 4.

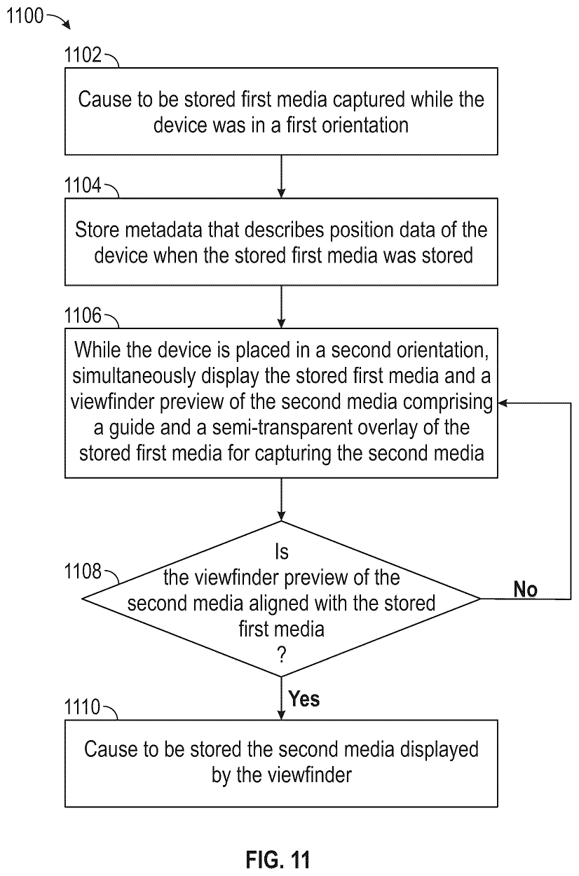

FIG. 11 is flowchart of a detailed illustrative process for capturing a target area of a viewfinder preview in multiple orientations, in accordance with embodiments of the disclosure. In various embodiments, the individual steps of process 1100 may be implemented by one or more components of the devices and applications of FIGS. 1-10. Although the present disclosure may describe certain steps of process 1100 (and of other processes described herein) as being implemented by certain components of the devices and applications of FIGS. 1-10, this is for purposes of illustration only, and it should be understood that other components of the devices and systems of FIGS. 1-10 may implement those steps instead.

Process 1100 begins at step 1102, where a camera application (e.g., camera application 108 as described in FIGS. 1A-1B), via control circuitry (e.g., control circuitry 804 or 911 of FIGS. 8 and 9, respectively), causes to be stored in non-transitory memory (e.g., non-transitory memory 808 of FIG. 8) a first media item captured while a user device was positioned in a first orientation. In some embodiments, the user device is user equipment 907, 908 and 910 of FIG. 9. In some approaches, the first captured media item is the first media item described in further detail as related to FIGS. 1B, 3 and 4 or first media item 602 as further described in reference to FIG. 6. In some implementations, the first captured media item is captured and stored in any manner as described in reference to FIGS. 1-4 and 6-7. For example, the camera application receives a user-interface input to capture media displayed in the viewfinder preview of the camera interface.

At step 1104, the camera application, via the control circuitry, causes to be stored the metadata that describes the position data of the user device when the first media item was captured and stored. In some embodiments, the metadata is the metadata of FIGS. 1B, 2 and 3 or metadata 604 of FIG. 6 and includes user device data such as device orientation, inertial measurements (pitch, yaw, roll), zoom level, GPS data, compass orientation, autofocus (AF) settings, and altitude. In some implementations, the metadata is stored in any manner as further described in FIGS. 1-4 and 6.

At step 1106, the user device is positioned in a second orientation, different from the first orientation, and the camera application displays a semi-transparent overlay (e.g., semi-transparent overlay 302 of FIG. 3 or semi-transparent overlay 610 of FIG. 6) and a guide (e.g., guide 612 of FIG. 6 or position guide 306 of FIG. 3) corresponding to the first captured media item, such that a viewfinder preview for capturing second media item may be aligned with the semi-transparent overlay to capture the same target area as the first captured item media. In some embodiments, the semi-transparent overlay and guide are displayed in any manner as further described in reference to FIGS. 3 and 6. For example, the semi-transparent overlay is a semi-transparent copy of first captured media item associated with the Statue of Liberty displayed in the viewfinder preview, captured while the user device is in the vertical orientation. In some implementations, the guide comprises a compass and numerical values representing the orientation and properties associated with the capturing of first media, as further described in reference to FIGS. 3 and 6. In some approaches, the second media is the second media item described in reference to FIGS. 3 and 4 or second media item 608 of FIG. 6.

At step 1108, the camera application, via the control circuitry, determines whether the viewfinder preview for capturing the second media item is properly aligned with the semi-transparent overlay corresponding to the first captured media item. The camera application determines if the viewfinder preview for capturing the second media item is sufficiently aligned with the semi-transparent overlay by continuously monitoring the live media feed of the viewfinder preview for capturing the second media item, as the user device is adjusted to conform to the orientation and properties associated with the first captured media item. In some embodiments, the camera application performs the monitoring in any manner as further described in reference to FIG. 6.

If the camera application, via the control circuitry, determines that the viewfinder preview for capturing the second media item is substantively out of range (i.e., not sufficiently aligned with the semi-transparent overlay) when compared to the values of the first captured media item, the semi-transparent overlay and guide are maintained on the camera interface and process 1100 returns to step 1106, where the user device may be continuously adjusted until sufficient alignment is achieved. In some embodiments, the camera application displays a visual indicator indicating a corrective measure for better alignment, as described further in reference to FIG. 6. If the camera application determines that the viewfinder preview for capturing the second media item is sufficiently aligned with the semi-transparent overlay, the semi-transparent overlay and guide are removed from the camera interface and process 1100 proceeds to step 1110.

At step 1110, the camera application, via the control circuitry, causes to be stored, in non-transitory memory, the second media item captured while the user device was positioned in the second orientation. In some embodiments, the second media item is captured by the camera equipment of the user device and stored in any manner as further described in reference to FIGS. 1-4 and 6-7.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
accessing, by a camera application of a device, media format parameters associated with another application installed on the device;
displaying, by the camera application, a viewfinder preview based on image data captured by at least one camera of the device;
displaying a bounding box overlayed over the viewfinder preview, wherein a size of the bounding box is based on the accessed media format parameters associated with the another application, and wherein the size of the bounding box is smaller than a size of the viewfinder preview;
receiving a user interface input to capture media; and
causing to be stored in non-transitory memory a first media item displayed by the bounding box, wherein the stored first media item excludes the image data outside of the bounding box.

2. The method of claim 1, further comprising causing to be stored in the non-transitory memory a second media item displayed by the viewfinder preview at a time when the first media item was stored.

3. The method of claim 1, wherein the media format parameters comprise a length of time of a video, and wherein the storing in the non-transitory memory the first media item displayed by the bounding box comprises:
storing a video of the length of time within the limit specified by the media format parameters of the another application.

4. The method of claim 1, further comprising:
accessing, by the camera application of the device, additional media format parameters associated with a plurality of additional applications installed on the device;
displaying a respective bounding box overlayed over the viewfinder preview for each additional application of the plurality of additional applications, wherein a size of each respective bounding box is based on respective media format parameters of the plurality of additional applications; and
causing to be stored in the non-transitory memory a respective media item displayed by each respective bounding box.

5. The method of claim 4, wherein the media format parameters associated with the another application comprise a shape of the bounding box, and wherein the shape of the displayed bounding box is based on the shape specified by the media format parameters associated with the another application.

6. The method of claim 4, further comprising:
generating for display a user interface for selecting additional applications associated with the plurality of other additional applications, wherein the plurality of additional applications is selected based on inputs received via the user interface for selecting applications.

7. The method of claim 1, wherein the stored first media item is a video comprising a plurality of frames, the method further comprising:
performing an image analysis, using a machine learning model, of the image data of each frame of the plurality of frames of the stored first media item, wherein the image analysis comprises:
comparing the image data associated with each frame of the stored first media item with historical data related to other stored media items that have been uploaded to at least one service associated with at least one additional application selected associated with a plurality of additional applications installed on the device; and
identifying a degree of similarity between the image data associated with each frame of the stored first media item and the historical data related to the other stored media items; and
based on the image analysis, displaying a recommendation to upload a particular frame of the plurality of frames of the stored first media item to a particular additional application selected associated with the plurality of other additional applications.

8. The method of claim 1, wherein the accessing, by the camera application of the device, the media format parameters associated with the another application installed on the device comprises receiving the media format parameters via an API associated with the camera application of the device, wherein the API associated with the camera application of the device selectively allows third-party applications to communicate preferred media format parameters to the device.

9. The method of claim 1, wherein the causing to be stored in the non-transitory memory the first media item displayed by the bounding box comprises storing metadata associated with the another application corresponding to the bounding box.

10. The method of claim 1, further comprising:
performing an image analysis, using a machine learning model, of the image data within the viewfinder preview, wherein the image analysis comprises:
comparing the image data with historical data related to media uploaded to the another application; and
identifying a degree of similarity a match between the image data and the historical data;
based on the image analysis, determining a preferred position of the bounding box within the viewfinder preview; and
wherein the generating for display the bounding box comprises automatically positioning the bounding box in the preferred position.

11. The method of claim 1, wherein the media format parameters associated with the another application are first media format parameters, and wherein the first media format parameters comprise a first length of time of a video, the method further comprising:
accessing, by the camera application, second media format parameters associated with a second application installed on the device, wherein the second media format parameters comprise a second length of time of a video; and
causing to be captured two separate media items, wherein a first captured media item is captured using the first length of time associated with the another application and a second captured media item is captured using the second length of time associated with the second application, wherein the first captured media item and the second captured media item are videos.

12. The method of claim 1, wherein the first media item was stored while the device was in a first orientation, the method further comprising:
storing metadata that describes position data of the device when the stored first media item was stored;
while the device is placed in a second orientation, different from the first orientation:
generating for display on the viewfinder preview a guide for capturing a second media item, wherein the guide comprises:
positioning prompts based on the stored metadata that describes the position data of the device when the first media item was stored; and
a semi-transparent overlay of the stored first media item;
causing to be stored in the non-transitory memory the second media item displayed by the viewfinder preview.

13. The method of claim 12, further comprising:
simultaneously displaying the stored first media item and the viewfinder preview of the second media item, wherein the viewfinder preview of the second media item is the semi-transparent overlay over the stored first media item;
determining that a target area in the viewfinder preview of the second media item is aligned with the corresponding area in the stored first media item; and
causing to be stored in the non-transitory memory the second media item.

14. The method of claim 13, further comprising:
determining that the positioning prompts based on the stored metadata that describe the position data of the device when the first media item was stored indicates that the target area in the viewfinder preview of the second media item is not aligned with the corresponding area in the stored first media item; and
displaying a visual indicator indicating a corrective measure for aligning the viewfinder preview of the second media item with the stored first media item.

15. The method of claim 1, further comprising:
causing to be stored in the non-transitory memory a first media identifier of the first media item with a second media identifier for a second media item, such that the first media item and the second media item are stored as a pair.

16. A method comprising:
accessing, by a camera application of a device, media format parameters associated with another application installed on the device;
displaying, by the camera application, a viewfinder preview based on image data captured by at least one camera of the device;
displaying a bounding box overlayed over the viewfinder preview, wherein a size of the bounding box is based on the accessed media format parameters associated with the another application, and wherein the size of the bounding box is smaller than a size of the viewfinder preview;
receiving a user interface input to capture media; and
causing to be stored in non-transitory memory a first media item displayed by the viewfinder preview and causing to be stored metadata for the first media item that defines location and the size of the bounding box.

17. A system comprising:
a non-transitory memory; and
a control circuitry configured to:
access, by a camera application of a device, media format parameters associated with another application installed on the device;
an input/output (I/O) circuitry configured to:
display, by the camera application, a viewfinder preview based on image data captured by at least one camera of the device;
display a bounding box overlayed over the viewfinder preview, wherein a size of the bounding box is based on the accessed media format parameters associated with the another application, and wherein the size of the bounding box is smaller than a size of the viewfinder preview;
receive a user interface input to capture media; and
wherein the control circuitry is further configured to:
cause to be stored in the non-transitory memory a first media item displayed by the bounding box, wherein the stored first media item excludes the image data outside of the bounding box.

18-19. (canceled)

20. The system of claim 17, wherein the control circuitry is further configured to:
access, by the camera application of the device, additional media format parameters associated with a plurality of additional applications installed on the device;
wherein the I/O circuitry is further configured to:
display a respective bounding box overlayed over the viewfinder preview for each additional application of the plurality of additional applications, wherein a size of each respective bounding box is based on respective media format parameters of the plurality of additional applications; and
wherein the control circuitry is further configured to:
cause to be stored in the non-transitory memory a respective media item displayed by each respective bounding box.

21-22. (canceled)

23. The system of claim 17, wherein the stored first media item is a video comprising a plurality of frames, the control circuitry further configured to:
perform an image analysis, using a machine learning model, of the image data of each frame of the plurality of frames of the stored first media item, wherein the image analysis comprises:
comparing the image data associated with each frame of the stored first media item with historical data related to other stored media items that have been uploaded to at least one service associated with at least one additional application selected associated with a plurality of additional applications installed on the device; and
identifying a degree of similarity between the image data associated with each frame of the stored first media item and the historical data related to the other stored media items; and
wherein the I/O circuitry is further configured to:
based on the image analysis, display a recommendation to upload a particular frame of the plurality of frames of the stored first media item to a particular additional application selected associated with the plurality of other additional applications.

24-25. (canceled)

26. The system of claim 17, wherein the control circuitry is further configured to:
perform an image analysis, using a machine learning model, of the image data within the viewfinder preview, wherein the image analysis comprises:
comparing the image data with historical data related to media uploaded to the another application; and
identifying a degree of similarity a match between the image data and the historical data;
based on the image analysis, determine a preferred position of the bounding box within the viewfinder preview; and
wherein the I/O circuitry is configured to:
generate for display the bounding box by automatically positioning the bounding box in the preferred position.

27-80. (canceled)
